(19) United States
(12) Patent Application Publication
(10) Pub. No.: US 2014/0150073 A1
(43) Pub. Date: May 29, 2014

(54) AUTHENTICATION IN A WIRELESS TELECOMMUNICATIONS NETWORK

(71) Applicant: Nicholas Bone, Thatcham (GB)

(72) Inventor: Nicholas Bone, Thatcham (GB)

(73) Assignee: VODAFONE IP LICENSING LIMITED, Newbury, Berkshire (GB)

(21) Appl. No.: 13/823,572

(22) PCT Filed: Sep. 14, 2011
(86) PCT No.: PCT/GB2011/051718

§ 371 Date: Jul. 2, 2013

(30) Foreign Application Priority Data
Sep. 14, 2010 (GB) 1015322.9

(51) Int. Cl. H04W 12/06

(52) U.S. Cl. CPC H04W 12/06
USPC 726/5

(57) ABSTRACT

To facilitate authentication over a wireless access network, it is proposed to provide a hub device having an authentication storage means (i.e. a (U)SIM) to which one or more machine devices are connected. Each machine devices connects to a wireless access network and in order to authenticate with that network requests authentication information from the hub device. The core network of the wireless access network, authenticates each machine device and provides the machine devices with parallel access to the access network in accordance with authentication information obtained from the hub device. The authentication information is unique to the respective machine device but also associated with information stored on the authentication storage means of the hub device.

### FIELD OF THE INVENTION

The invention relates to a method for authenticating large numbers of devices to a wireless telecommunications network.

### BACKGROUND TO THE INVENTION

As a consequence of the decreasing costs of wireless telecommunications apparatus, tighter safety and climate regulation and vigorous market competition, an ever increasing number of devices (“machines”) are being provided with wireless telecommunications apparatus to facilitate additional information services. A particular driving factor in this trend has been the provision of wireless services to so-called machine to machine (M2M) solutions.

The term “M2M” has been used to describe applications in such diverse fields as: tracking and tracing; payment; remote maintenance; automotive and electronic toll; metering; and consumer devices. The augmentation of M2M to allow wireless communications between devices (often referred to as mobile M2M) makes new services possible in some cases (within the automotive industry, for instance) and in others extends existing M2M services (within the field of smart metering).

With mobile M2M, machines numbering in the order of millions and located anywhere within mobile network coverage, can be simultaneously monitored to provide real-time information that an individual or enterprise can analyze and act upon.

It is predicted that large numbers of “machines” will require access to wide-area mobile networks (such as the GSM, GPRS and/or 3G cellular networks). Each of these machines may only require authentication very occasionally but may have all the basic equipment to allow connection to at least one access network when that is required. However, just requiring that each device be allowed to authenticate itself to the network from time to time, may undermine the benefits of certain mobile M2M services (particularly those services that are predicated on a low cost machine/service).

Consider the implications of providing all such devices with a separate, provisioned SIM card. For each SIM card, the network operator must create a corresponding subscription and “provision” the SIM with a valid MSISDN corresponding to that subscription (i.e. a telephone number), both for the reservation of the MSISDN (regulators such as the ITU assign ranges of MSISDN numbers to operating companies) and overheads in registering the selected number for use with a given access network.

Where that SIM appears no longer (or never to have been) used for a predetermined period, the network operators typically note this fact and initiate a “quarantine” process for returning the telephone number to the set of available numbers. Of course, this quarantining process has an associated cost: so too does reassigning that MSISDN number as ultimately will happen when it is confirmed unused after the quarantine period expires.

As the reader will readily appreciate, the provisioning of SIMs that are infrequently or never used represents a distinct inconvenience to the network operator. While this inconvenience is significant when considering the conventional provision of mobile telephones and data card/modems with SIMs, SIM-enablement of “machines” present additional problems simply by virtue of the number of these devices and their typical (low and sporadic) frequency of use. M2M applications are expected to increase significantly the number of unused or infrequently used SIMs and to cause a consequently greater level of disruption to the network operator who wishes to enable such devices. All the additional costs in terms of provisioning, quarantining (or keeping minimally active) etc of such machines can be relatively expensive and when compared with the potential market for the mobile M2M service may be found incompatible with low cost services.

Alternatively devices could have a “soft SIM” (a SIM module in software or firmware) instead, but this has major security issues, and there is still significant cost to the network operator (requiring heavy usage of the core network components in particular the home location register (HLR) and the authentication centre (AuC)) and arranging provisioning/creating subscriptions.

In a further alternative, it would be possible for devices to have some other form of authentication technology. However such a solution would require major network re-design, and could potentially prevents connection onto existing 3G and GSM networks.

It is therefore an object of the invention to obviate or at least mitigate the aforementioned problems.

In accordance with one aspect of the present invention, there is provided a system for facilitating authentication over a wireless access network, the system comprising:

a hub device having an authentication storage means, which is operable to provide authentication information during an authentication process;

at least one machine device being operable to connect to the wireless access network and having a communication interface with the hub device, through which a request for authentication information is made; and

a core network, which is operable to authenticate each machine device and provide said machine devices with parallel access to one or more access networks in accordance with authentication information obtained from the hub device.

It is preferred that a plurality of machine devices are provided with parallel access and the authentication information obtained from the hub device for each machine device includes a corresponding temporary identifier (such as the TMSI for UTRAN or GUTI for LTE) and a distinct key association (e.g. in LTE, K_ASME), each corresponding temporary identifier being related to a permanent identifier (e.g. an IMSI) associated with the hub device.

### BRIEF DESCRIPTION OF THE DRAWINGS

For a better understanding of the present invention, reference will now be made, by way of example only, to the accompanying drawings in which:

FIG. 1 illustrates the operation of the present invention.

### DETAILED DESCRIPTION

Rather than provide each machine with its own SIM and tolerate the level of signalling that that would entail, the invention facilitates authentication of multiple devices using the same (U)SIM.

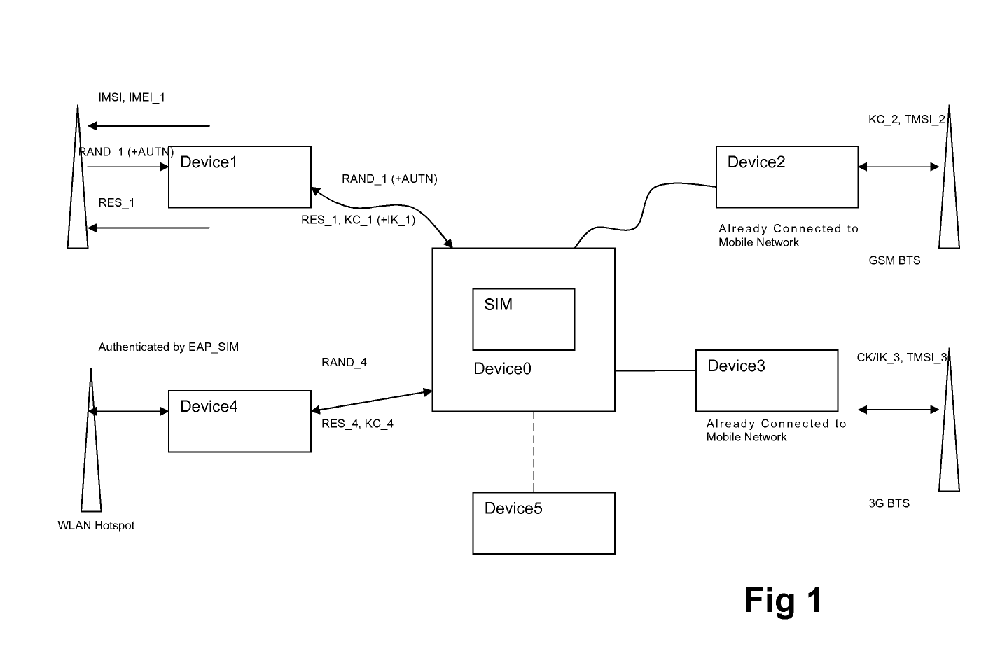

Typically, as shown in FIG. 1, the devices are joined to a SIM-containing device (referred to hereafter as the “hub” device) via a variety of short-range connections (USB, WLAN, ZigBee [RTM], NFC etc.) and/or long-range connections and secure channels.

When each device needs to authenticate to a wide-area mobile network (or heterogeneous access network) it forwards a challenge to the (U)SIM and receives back a RES and key material (Kc or CK∥IK).

Multiple devices can thus be connected substantially simultaneously, each with a distinct TMSI (or in LTE, GUTI) and key association (in LTE, K_ASME) but all related to the underlying IMSI, and billed against the same subscription.

To facilitate this behaviour in a cellular telecommunications access network (such as a GSM network, 3G network or LTE network), some changes to the HLR and other parts of the core network are required. In a first instance, the HLR must track multiple devices at once, and single out a “master” device (for example, the hub device) to receive incoming calls, SMS etc. In an alternative, the HLR may only track the “master” device, on the assumption that the other devices never need to be routed to (i.e. they have data-only connections and there is no incoming traffic accepted).

A number of mechanisms are available to indicate to the HLR which device is the “master”, examples include: a special flag in the IMSI (dedicated bit) which indicates when connecting or doing location-updates with the master; or use of the IMEI which is presented at connection or location update (with a separate record indicating which device is the master).

Further core network changes are necessitated by the invention:

The visitor location register (VLR), associated with a mobile switching centre (MSC) currently maintains only one record per IMSI, with associated TMSI and Kc (or CK∥IK for UMTS). To support the above, VLR must maintain multiple records i.e. same IMSI may have multiple TMSIs at once, and VLR must associate each TMSI with corresponding IMEI.

The HLR may maintain multiple records per IMSI, and associate each record with IMEI so it can track each device's location. This requires IMEI to be reported to HLR along with IMSI during Location Updates. This can be done using techniques such as the “Automatic Device Detection” facility standardised in 3GPP Release 6

Alternatively, where the HLR only tracks location of one device (e.g. “master” device for incoming calls, SMS etc.). Location Updates with the “master” device conveniently report a base IMSI (say IMSI_0) and other devices report an offset IMSI, say IMSI_0+1. The HLR then need only track updates reporting IMSI_0.

A number of implementations may be considered:

In a first embodiment, consider a vast array of sensors in a building or on a campus. With the present invention, a single SIM-holding device, to which sensors are locally connected, may be used to perform authentication on behalf of each sensor. Sensors have a low bandwidth radio (just to confirm that they are “OK” or “alert” every so often). The SIM-holding device is preferably portable (e.g. a security guard carrying a mobile phone); devices only temporarily in range.

In another embodiment, sensors are installed on parcels, delivery crates etc. travelling away from a depot, then back again, or between depots. They connect to the SIM-holding device when in depot.

In a third embodiment, consider a home energy system with multiple devices reporting usage, adapting usage, sending alarms etc. In this case the SIM-holding device is the home owner's mobile phone; and the owner is only around in the evening.

1. A system for facilitating authentication over a wireless access network, the system comprising:
a hub device having an authentication storage means, which is operable to provide authentication information during an authentication process;
at least one machine device being operable to connect to a wireless access network and having a communication interface with the hub device, through which a request for authentication information is made; and
a core network, which is operable to authenticate each machine device and provide said machine devices with parallel access to one or more access networks in accordance with authentication information obtained from the hub device.

2. A system as claimed in claim 1, wherein the request for authentication is a challenge to the authentication storage means and wherein the authentication information obtained from the hub device includes key material.

3. A system as claimed in claim 1, wherein a plurality of machine devices are provided with parallel access and the authentication information obtained from the hub device for each machine device includes a corresponding temporary identifier and a distinct key association, each corresponding temporary identifier being related to a permanent identifier associated with the hub device.

4. A system as claimed in claim 1, wherein the core network further includes a visited location register for storing temporary records of active machine devices, the visited location register.

5. A system as claimed in claim 1, where the core network further includes a home location register, the home location register being operable to maintain a database of the records of a plurality of temporary identifiers, where said temporary identifiers are each related to a shared permanent identifier, and to associate each record with a corresponding machine device identifier, thereby tracking each machine device's location.

6. A system as claimed in claim 1, where the core network includes a home location register, being operable to identify a master device from the at least one machine device to which incoming communications are to be directed, the master device being assigned as representative of any other machine devices associated with the hub device.

7. A method for facilitating authentication of at least one machine device over one or more wireless access networks via a hub device having an authentication storage means, the method comprising:
at the hub device,
receiving a request for authentication information from the at least one machine device; and
responding to the request with authentication information which includes a corresponding temporary identifier and a distinct key association, each corresponding temporary identifier being related to a permanent identifier associated with the hub device;
and in a core network associated with said one or more wireless access networks,
receiving the corresponding temporary identifier and distinct key association from said at least one machine device, and
authenticating said at least machine device, thereby providing said machine devices with parallel access to said one or more access networks
